(19) United States
(12) Patent Application Publication
(10) Pub. No.: US 2015/0033899 A1
(43) Pub. Date: Feb. 5, 2015

(54) Control Element for an Industrial Truck

(71) Applicant: Jungheinrich Aktiengesellschaft, Hamburg (DE)

(72) Inventors: Hendrik GEILSDORF, Hamburg (DE); Christoph WEGENER, Soegel (DE)

(73) Assignee: Jungheinrich Aktiengesellschaft, Hamburg (DE)

(21) Appl. No.: 14/336,673

(22) Filed: Jul. 21, 2014

(30) Foreign Application Priority Data
Jul. 22, 2013 (DE) 10 2013 012 176.0

(51) Int. Cl. G05G 11/00; G05G 1/04

(52) U.S. Cl. CPC G05G 11/00; G05G 1/04
USPC 74/490.15

(57) ABSTRACT

A control element for an industrial truck with two control levers (12, 14) and at least one switch (22, 24) arranged between the control levers, wherein the control levers (12, 14) are designed respectively for a biaxial movement (K) and are distanced from each other spatially such that the control levers, with the fingers of a hand positioned between the levers without grasping, and the at least one switch between the control levers can be operated.

The present invention relates to a control element for an industrial truck.

### BACKGROUND

A control element for an industrial truck became known from EP 1 350 668 A2, in which an armrest extends in the longitudinal direction of the vehicle and a plurality of control elements are arranged on a front end of the armrest. Of the control elements, at least two control elements have an operating section, wherein the operating sections are arranged in order to be operated by a hand resting on the armrest. For this, the operating sections are arranged along a curved line, which corresponds with an operating circle for the fingers of the hand resting on the armrest.

A control element for a work vehicle is known from WO 00/64801, in which the hand of an operator rests on a hood-shaped switch lever, which is pivotable around an axis. Buttons are arranged along the circumference, which can be operated by a hand lying on the switch lever via the thumb and pointer and middle fingers.

A control element for a forklift is known from EP 0 655 413, in which a steering wheel as well as switching means are arranged on a common control arm, wherein the position of the control arm in the driver's cab is adjustable.

A manually actuated control element with three switch levers for controlling a reach truck is known from GB 2,328,005. The three switch levers are pivotable around a common axis, wherein an outer switch lever is provided with additional buttons.

A manually actuated control device for an operating station of an industrial truck is known from EP 1 693 334 B1, with a stationary, raised rest for the ball of the hand lying laterally next to and in front of the standing or seated operator, with an upper support surface, on which the ball of the hand of the operator can rest from above, a front surface facing away from the operator and a surface facing the operator and at least one control element for a function of the industrial truck on the end of the rest for the ball of the hand facing away from the support surface, which is arranged such that it is operable with at least one finger, wherein the front and rear surfaces are dimensioned such that the rest for the ball of the hand can be gripped between the fingers and a proximal section of the ball of the hand facing the wrist and a section lying in front of the front surface and lowered with respect to the support surface is arranged such that the fingers of the hand lying on the support surface can be curved and the control element is arranged on the side of the lowered section lying opposite the front surface. The support surface and the lowered section as well as the front and rear surfaces are formed on a shell body, wherein at least one control element is engaged in the shell body laterally such that it is operable with the thumb of one hand, which rests on the support surface.

### SUMMARY

The object of the invention is to create a control element for an industrial truck, which permits an ergonomically beneficial operation for as many functions as possible even in the case of different hand sizes and avoids an accidental operating error even when work gloves are worn.

According to the invention, the object is solved through a control element with the characteristics of: a control element for an industrial truck with two control levers (12, 14) and at least one switch (22, 24) arranged between the control levers, wherein the control levers (12, 14) are designed respectively for a biaxial movement (K) and are distanced from each other spatially such that the control levers, with the fingers of a hand positioned between the levers without grasping, and the at least one switch between the control levers can be operated. Advantageous embodiments are the subject of the dependent claims.

The control element according to the invention is provided and determined for an industrial truck. The control element has two control levers and at least one switch arranged between the control levers. The control levers are designed respectively for a biaxial movement so that each control lever can be tilted freely in each direction. The control levers are distanced from each other spatially such that a hand positioned between the operating levers can operate both control levers and the at least one switch with the fingers. Both control levers can be operated with the balls and/or fingers of one hand without grasping the control levers so that both control levers can be operated simultaneously with one hand without great effort or an unnatural hand position. Both control levers can preferably be moved only via the fingers without a change in the position of the hand. The distance between the control levers is also large enough so that an operating error on the control lever or the at least one switch is excluded.

In order to create a good support surface for the hand, the control lever has a convexly widening lever end, which forms a support surface for the palm of the hand, in particular for the ball of the hand.

### BRIEF DESCRIPTION OF THE DRAWINGS

FIG. 1 is an isometric view of one alternative embodiment of a control element for an industrial truck.

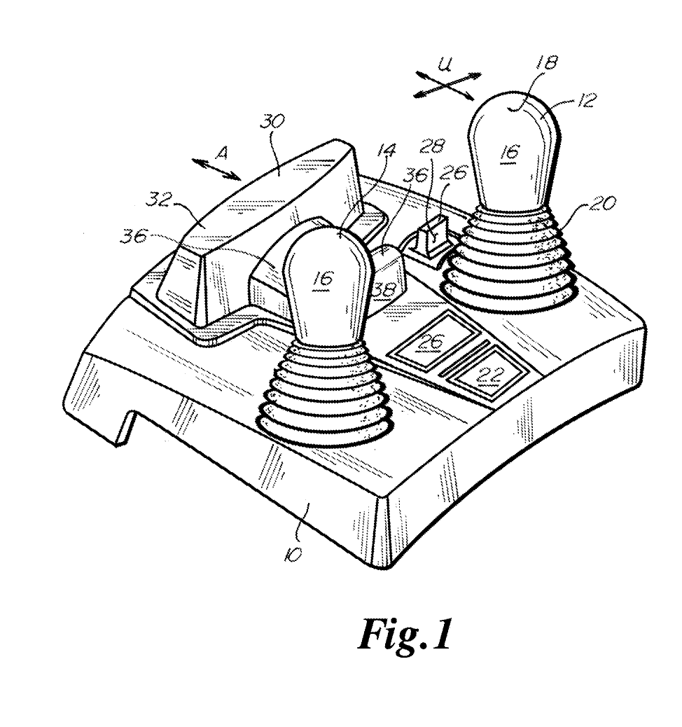

### DETAILED DESCRIPTION

In a preferred embodiment, the switch(es) is/are designed between the control levers as buttons. The buttons can cover different functions for the operation of the industrial truck. For example, one of the buttons can be the signal transmitter. The other button can be provided for example as the confirmation button.

In a preferred embodiment, the control element is provided with a shell-like housing cover, from which the control levers protrude and in which the at least one button is arranged in a slightly sunken manner. The housing cover serves as a rest for the hand or the ball of the hand of an operator. The control levers can be operated from this position. An accidental operation of the button is avoided due to the slightly sunken button.

In a preferred embodiment, a selector switch is assigned to at least one of the control levers, which covers one or more hydraulic functions. The selector switch is preferably designed as a toggle switch, which has two defined switch positions. A rocker switch can also be provided.

In another preferred embodiment, a sliding switch is provided centered with respect to the control levers, which has a pusher extending parallel to an imaginary connection line between the control levers. The sliding switch is slid diagonally to the connection line for the switchover.

A preferred exemplary embodiment for the control element is explained in greater detail below.

The single figure shows a shell-like housing part 10, which is preferably made of plastic and integrated in the inner panelling on an operating station for an industrial truck. Two control levers 12 and 14 protrude from the housing part 10. Each of the control levers 12, 14 have a lever head 16, which widens upwards and forms a support surface 18 for the palm of a hand. Each of the control levers 12, 14 is moveable like a joystick along the pictured double arrow K. The movement in both arrow directions can hereby be overlain so that each control lever can be pivoted in any direction. Alternatively, lane guidance is also possible via a corresponding shift gate.

The control levers 12 and 14 each have gaiter 20, which has a concertina-like folded flat material, in order to shield a lever mechanism of the control levers from environmental influences like dust, dirt and the like.

Two buttons 22, 24 are arranged between the control levers 12, 14. The button 22 is equipped as a signal transmitter for an acoustic warning signal. The button 24 is provided for example as a confirmation button. When using industrial trucks, there are functions, for example during the use of hydraulically operated clamps or holding arms, in which a separate confirmation by the operator must take place before an opening of the clamp or of the holding arms in order to avoid an accidental opening and actuation. Button 24 is an example of such a confirmation button. The buttons 22 and 24 are integrated and slightly sunken in the housing 10.

A switch 26 is designed as a toggle switch and protrudes from the housing 10. The toggle switch 26 is provided for switching between different hydraulic functions. The toggle switch 26 can hereby be designed such that its toggle lever 28 is always located in the shown neutral position and is switched forward or backward. Alternatively, the toggle switch 26 can also be designed such that the toggle lever 28 has a defined front position and a defined rear position, between which the switching is performed.

The control element also has a sliding lever 30, which is slidable along the double arrow A. The sliding lever 30 has a front sliding body 32 and a rear sliding body 34. The sliding bodies 32 and 34 are interconnected by a web 36. The rear sliding body 34 is thereby arranged such that a hand resting on the control lever 12 or 14 can push with the index finger and the middle finger against the rear wall 38 of the rear sliding body 34 in order to push the pusher in the direction of the double arrow A away from the control lever. When pulling the pusher, the rear sliding body 34 can be partially gripped from behind with the index finger so that the pusher is pulled overall towards the control levers 12 and 14.

A control element for an industrial truck with two control levers (12, 14) and at least one switch (22, 24) arranged between the control levers, wherein the control levers (12, 14) are designed respectively for a biaxial movement (K) and are distanced from each other spatially such that the control levers, with the fingers of a hand positioned between the levers without grasping, and the at least one switch between the control levers can be operated.

The control element according to the paragraph above, characterized in that each of the control levers (12, 14) has a convexly widening lever end (16).

The control element according to one of the preceding two paragraphs, characterized in that the switch(es) (22, 24) is/are designed as buttons.

The control element according to one of the preceding three paragraphs, characterized in that two buttons are provided between the control levers (12, 14).

The control element according to one of the preceding four paragraphs, characterized in that a housing cover (10) is provided from which the control levers (12, 14) protrude and in which the at least one switch (22, 24) is arranged in a sunken manner.

The control element according to the preceding paragraph, characterized in that the ball of the hand positioned between the levers rests on the housing cover.

The control element according to one of the preceding six paragraphs, characterized in that a selector switch (26) for one or more hydraulic functions on the industrial truck is assigned to at least one control lever (12).

The control element according to one of the preceding seven paragraphs, characterized in that a sliding switch (30) is provided centered with respect to the control levers, which has at least one sliding body (32, 34) extending parallel to an imaginary connection line between the control levers (12, 14), wherein the sliding switch (30) is slid diagonally to the connection line for the switchover.

1. A control element for an industrial truck comprising two control levers and at least one switch arranged between the control levers, wherein the control levers are designed respectively for a biaxial movement and are distanced from each other spatially such that the control levers, with the fingers of a hand positioned between the levers without grasping, and the at least one switch between the control levers can be operated.

2. The control element according to claim 1, characterized in that each of the control levers has a convexly widening lever end.

3. The control element according to claim 1, characterized in that the at least one switch is designed as at least one button.

4. The control element according to claim 1, characterized in that two buttons are provided between the control levers.

5. The control element according to claim 1, characterized in that a housing cover is provided from which the control levers protrude and in which the at least one switch is arranged in a sunken manner.

6. The control element according to claim 5, characterized in that a ball of the hand positioned between the levers rests on the housing cover.

7. The control element according to claim 1, characterized in that a selector switch for one or more hydraulic functions on the industrial truck is assigned to at least one control lever.

8. The control element according to claim 1, characterized in that a sliding switch is provided centered with respect to the control levers, which has at least one sliding body extending parallel to an imaginary connection line between the control levers, wherein the sliding switch is slid diagonally to the connection line for the switchover.
